(19) United States
(12) Patent Application Publication
(10) Pub. No.: US 2011/0045820 A1
(43) Pub. Date: Feb. 24, 2011

(54) Method for recovering connectivity in the event of a failure in a radio communications system and controlling node thereof

(75) Inventors: Alois Huber, Wien (AT); Thomas Ulrich, Bad Dürkheim (DE); Alexander Vesely, Feldbach (AT); Richard Waldhauser, München (DE)

Correspondence Address: STAAS & HALSEY LLP, SUITE 700, 1201 NEW YORK AVENUE, N.W., WASHINGTON, DC, 20005, US

(73) Assignee: NOKIA SIEMENS NETWORKS GMBH & CO. KG, Munich (DE)

(21) Appl. No.: 12/310,777

(22) PCT Filed: Sep. 4, 2007
(86) PCT No.: PCT/EP2007/059255

§ 371 Date: Apr. 6, 2010

(30) Foreign Application Priority Data
Sep. 6, 2006 (EP) 06018654.1

(51) Int. Cl. H04W 24/00

(52) U.S. Cl. 455/424

(57) ABSTRACT

A first controlling node controlling a first group of controlling nodes in a radio communications system has a control link established by a control unit based on accessing a database storing information relating to connectivity relationships between the first controlling node and the first group is accessed by a control unit. When a detecting unit detects the failure of the first controlling node on the control link, a transceiver uses the information in the database to connect to the first group and restore connectivity to the first group of nodes.

### CROSS REFERENCE TO RELATED APPLICATIONS

This application is the U.S. national stage of International Application No. PCT/EP2007/059255, filed Sep. 4, 2007 and claims the benefit thereof. The International Application claims the benefits of European Application No. 06018654 filed on Sep. 6, 2006, both applications are incorporated by reference herein in their entirety.

### BACKGROUND

The method described below relates to the field of preserving the connectivity between nodes in radio communications systems, in particular when a failure of a node is detected.

In present day radio communications systems, such as UTRAN (Universal Mobile Telecommunications System Terrestrial Radio Access Network), when UEs (User Equipments), such as mobile stations, require radio resources in order to set up a service, the UEs transmit a request for allocation of radio resources to a RRM (Radio Resource Manager). Within UTRAN, a RNC (Radio Network Controller) acts as the RRM, for the geographical area it controls. Each RNC controls a group of nodes, the nodes being a BS (Base Station) and/or a NodeB, each node in turn controlling an area known as a cell. BSs and/or NodeBs allow UEs located within their respective cells to access a core network such as a PSTN (Public Switched Telephone Network) and/or the internet.

However, this type of system architecture has the drawback that in the event of a failure of the RNC, which can be a permanent one in the case of a hardware failure or a temporary one in the case of a short power outage, all the nodes included in the group which is under the RNC's control will loose connectivity to the PSTN and/or the internet. Consequently, UEs will in turn loose connectivity and all running services are terminated.

The fact that the RNC is a single point of failure reduces the efficiency of the radio communications system. Data throughput is drastically reduced, the time necessary for completing a data transmission to and from a UE is greatly increased due to the fact that a UE has to re-start the necessary procedures for re-connecting to the radio communications system, QoS (quality of service) requirements for data transmissions can not be maintained, requested services can not be provided or are dropped, radio resources lost, etc.

In order to overcome the above drawback and the negative effects affecting data transmissions, the following solutions have been proposed:

Providing for hardware back-ups for the each RNC, by increasing the redundancy of the different hardware elements in an RNC, e.g. processing boards etc and/or permitting for such hardware to be hot-swappable. However, this solution incurs high manufacturing costs for each RNC as well as increasing investment costs when building a radio communications system with such RNCs. Furthermore, in the event of failures, time is still lost in ensuring that the redundant hardware elements replace the failed ones within the shortest time possible, as well as causing connectivity problems with nodes and UEs. Additionally, in the event of a failure, connectivity and services are lost for all cells controlled by the RNC.

Co-locating the RRM at each node, BS or nodeB, so that the RRM only services requests from within the cell of the node. In case of a failure, only the cell and the UEs located within the cell are affected instead of all cells as mentioned hereinabove. However, this solution requires a large number of RRM entities, as each and every cell effectively requires to have at least one such RRM, integrated or coupled to the nodes. Furthermore, all RRMs need to be co-ordinated with each other due to the fact that radio resources are limited and have to be shared between the different UEs, leading to a large amount of signalling being generated.

In the event that a UE having requested and obtained services in a cell moves to another cell, a handover procedure needs to be executed between the nodes. This handover procedure also includes the negotiation procedures executed between the source node and the target node in order to verify that the same services can be maintained in the new cell. Further signalling will also be generated between the nodes as measurements such as interference measurements need to be forwarded between the nodes and from the co-located RRMs, so that all nodes have accurate information when performing the handover procedures.

Additionally, nodes will also have to communicate with HLRs/VLRs (Home Location Registers/Visitor Location Registers) in certain cases, further increasing the amount of signalling. In the case that a requested service is granted based on a valid subscription, HLR/VLR data would have to be retrieved by the node. In the case of a node failing a HLR/VLR might have to be accessed in order to restore all the lost data. This can be performed by re-initialising the security contexts or by NAS (Network Access Server) signalling to name but a few. In the case that a source node requires information for a target node, for an UE in idle mode, the HLR/VLR has to be checked and if the stored information is not up-to-date more update signalling is required.

The large amount of generated signalling reduces the efficiency of the radio communications system due to the fact that the time required for processing increases a lot and thus causing an increase in the time required for the system to be stable. Additionally, a lot of processing power is required in order to accommodate the increased amount of signalling further increasing manufacturing and/or infrastructure costs.

Alternatively, a plurality of redundant RRMs serving a group of nodes can be provided. The drawback of this solution is that due to the fact that a number of redundant RRMs exist, each node requires to have a RRM client function in order to be able to access each RRM in case of loosing connectivity with a serving RRM, as well as having to request a reservation of resources from the RRM during a call set-up procedure, in order to avoid the case wherein two or more RRMs trying to set-up a connection to the same node at the same time. This increases the complexity of the signalling as well as the time required to ensure that the call set-up is successful. Furthermore, RRMs that serve the same nodes have to dynamically exchange status information between them in order to ensure that each RRM has the latest up-to-date status information. Additionally, measurements such as interference measurements need to be forwarded from the nodes to the RRMs. This causes a continuous signalling to take place reducing data throughput within the radio communications system.

A need therefore exists for a technique that counters the above mentioned drawbacks and provides for the reduction of signalling required when re-connecting after a loss of connectivity and reducing the time that connectivity is lost, as well as optimising the architecture of a radio communications system by reducing the amount of redundant devices required.

### SUMMARY

With the present invention the above mentioned issues are resolved. The proposed technique provides a simple and efficient way for, in the event of a failure, restoring connectivity within a very short time without having to reduce the efficiency of the radio communications system with excess signalling and the maintenance of a large and complicated system architecture.

The method restores connectivity in the event of a failure of a first controlling node of a plurality of controlling nodes, the first controlling node controlling a first group of nodes, in a radio communications system, includes:
maintaining a database in at least one further controlling node of the plurality, the further controlling node controlling a further group of nodes, wherein the database stores information relating to connectivity relationships between the first controlling node and the first group;
establishing a control link between the first and the at least one further controlling nodes;
detecting by the at least one further controlling node of the failure of the first controlling node on the control link, and
connecting by the at least one further controlling node using the information to the first group, upon detection of the failure.

The independent controlling node arranged for restoring connectivity in the event of a failure of a first controlling node of a plurality of controlling nodes, the first controlling node controlling a first group of nodes, in a radio communications system, the controlling node being further arranged to control a further group of nodes, includes:
a database storing information relating to connectivity relationships between the first controlling node and the first group;
a control unit adapted to establish a control link to the first controlling node;
a detecting unit to detect the failure of the first controlling node on the control link, and
a transceiver using the information upon detection of the failure, to connect to the first group.

The technique is further advantageous as it ensures the redundancy of the controlling node by the network architecture implemented in the radio communications system rather than ensuring the redundancy using hardware such as duplication of hardware within the controlling node.

The connection is set-up at least on a control plane using an internet protocol between the at least one further controlling node and the first group of nodes, ensuring that through the connection control can be established over the group of nodes as well as simplifying the connection set-up through the use of an existing protocol, thus avoiding the necessity of having to use a proprietary addressing scheme.

The at least one further controlling node uses at least one service parameter when connecting to the first group, the at least one service parameter differentiating the connection by specifying at least one of the following: an importance of each node of the first group, an importance of a user equipment active within the first group, an importance of a communication taking place within the first group, an importance of a service provided by each node of the first group. With this differentiation, an optimised load balancing can be achieved as the further controlling node has to maintain connectivity with its own nodes as well as with the nodes it is taking over. In this way, the further controlling node can differentiate between taking over all the nodes or a number of them. Thus increasing the amount of control the further controlling node has in making decisions when called upon to maintain connectivity. Furthermore, as the parameters indicate an importance of a node, user equipment, service or communication within the group of nodes being taken over, the further controlling node taking over the failed controlling node does not need to transmit any additional requests to a central network management node, thus reducing the amount of signalling as well as moving the decision making and management of the failure closer to the point where it occurred. Thus increasing the efficiency, optimisation and response time of the radio communications system. The parameter is at least a radio bearer service parameter or at least an allocation retention priority parameter.

The set-up connection is a one to one connection between the at least one further controlling node and each node of the first group of nodes, establishing a simple and effective way by which to control each node. Furthermore, as the at least one further controlling node establishes an independent connection directly with each node of the group whose controlling node has failed and at the same time still maintaining active connections with its own group of node, the need to have additional controlling nodes as backup controlling nodes optimises and simplifies the architecture of the radio communications system.

The set-up connection further includes an authentication and authorization between the at least one further controlling node and the first group of nodes, ensuring that control and connectivity is fully established between the two sides.

The detection of the failure over the control link detects a failure of a logical connection includes at least a radio network sublayer application part protocol and/or a physical connection between the first and the at least one further controlling nodes, thus enabling a distinction between types of failures and so being in a position to effect any further appropriate measures after the connectivity has been re-established. Also as the detection is done over the control link, it can be done in a very short time as traffic over it is minimal, only control related.

The at least one further controlling node upon connecting to the first group of nodes retrieves dynamic data from the first group of nodes and/or from at least one user equipment of a plurality of user equipments present within the first group of nodes, the dynamic data relating to at least one of the following: configuration, connectivity, load situation data of each one of the first group of nodes and of the at least one user equipment. The retrieval of data enabling the further controlling node to quickly update the database it maintains with the latest data so that services and transmissions are not greatly disrupted.

The at least one further controlling node once connected to the first group of nodes updates a database of at least one supervising controlling node of a plurality of supervising controlling nodes, the at least one supervising controlling node controlling the first controlling node. Therefore, making the supervising controlling node aware of the change that has taken place within the radio communications system and thus increasing the effectiveness of the management of the radio communications system, as all information maintained in a supervising controlling node is up-to-date.

Once the failure is resolved, the first controlling node re-connects to the first group of nodes and the at least one further controlling node releases the connection to the first group of nodes, thus allowing the data load to be moved back to the original controlling node and removing it from the further controlling node.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of a radio communications system according to the related art.

FIG. 2 is a block diagram of a radio communications system implementing the technique described herein.

FIG. 3 is a flow chart of the technique described herein.

FIG. 4 is a block diagram of an arrangement for executing the technique described herein.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

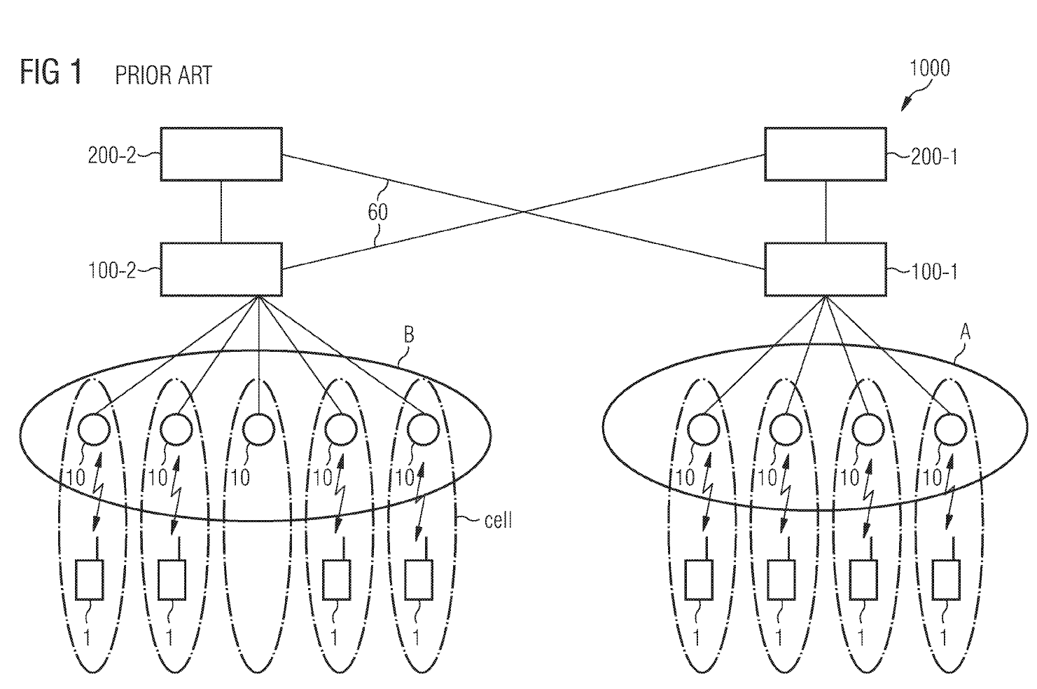

FIG. 1 shows a related art radio communications system 1000. The radio communications system 1000 includes mobile devices (Ues) 1, which in turn communicate with nodes 10 over an air-interface. Nodes 10 can be BSs (Base Stations) and/or NodeBs. Each node 10 manages an area known as a cell, and provides access for UEs 1 to core networks such as the PSTN (Public Switched Telephone Network) and/or the internet. Each node 10 is coupled to and controlled by a controlling node 100-1, 100-2. Controlling node 100-1, 100-2 can be RNCs (Radio Network Controllers) and/or CPSs (Control Plane Servers). Every controlling node 100-1, 100-2 is also coupled to and controlled by at least one supervising controlling node 200, for example a GGSN (Gateway GPRS (General Packet Radio Service) Service Node). Each controlling node 100-1, 100-2 controls a plurality of nodes 10 which together form a group. In FIG. 1, groups A and B are thus formed.

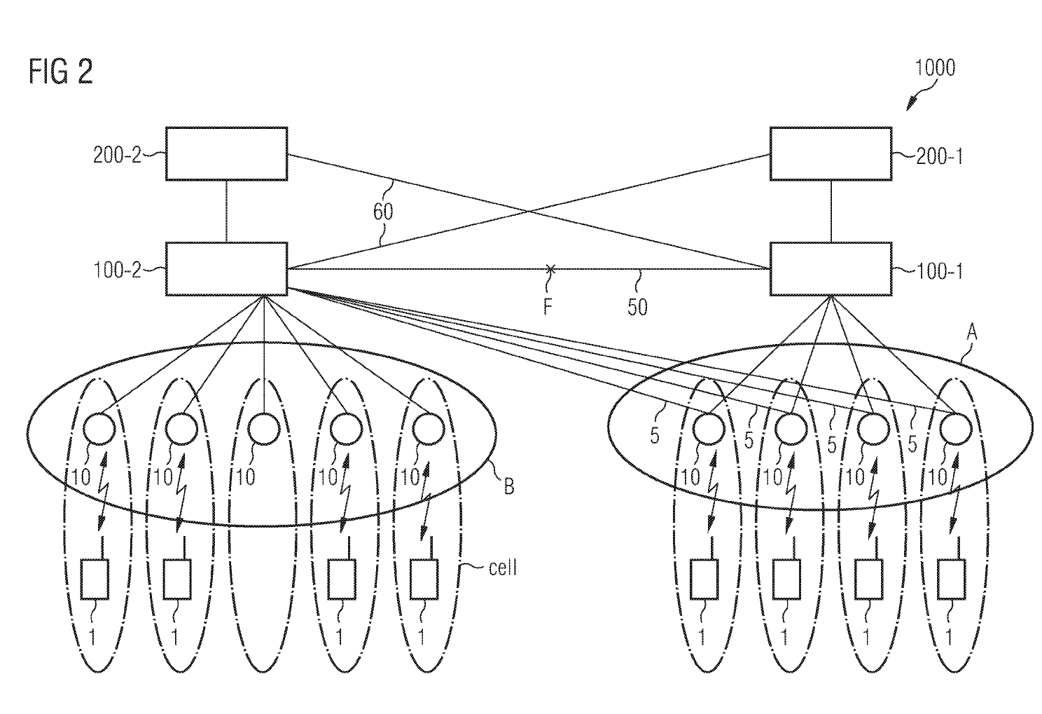

FIG. 2 shows a radio communications system 1000, wherein the technique is applicable. It is identical with FIG. 1 but differs only in that controlling nodes 100-1, 100-2 also establish a control link 50 between them for example over the lur (or the elur) interface, in order to be able to exchange control messages and to monitor and detect a failure of one controlling node 100-1, 100-2 by another one. A failure detected can be the failure of a logical and/or of a physical connection between controlling nodes 100-1, 100-2 detected over control link 50. For example, a logical failure being the failure to detect specific control messages within a specific time period from a controlling node 100-1, 100-2 and a physical failure being the complete cessation of reception of any messages from a controlling node 100-1, 100-2.

In the illustrative example in FIG. 2, a failure F is detected over control link 50 of a first controlling node 100-1 controlling a first group of nodes A. The detection is effected by a further controlling node 100-2 controlling a further group of nodes B. The failure F detected can be the failure of a logical and/or of a physical connection between controlling nodes 100-1, 100-2 detected over control link 50. In particular, the logical connection over control link 50 can be at least a RNSAP (Radio Network Sublayer Application Part) protocol.

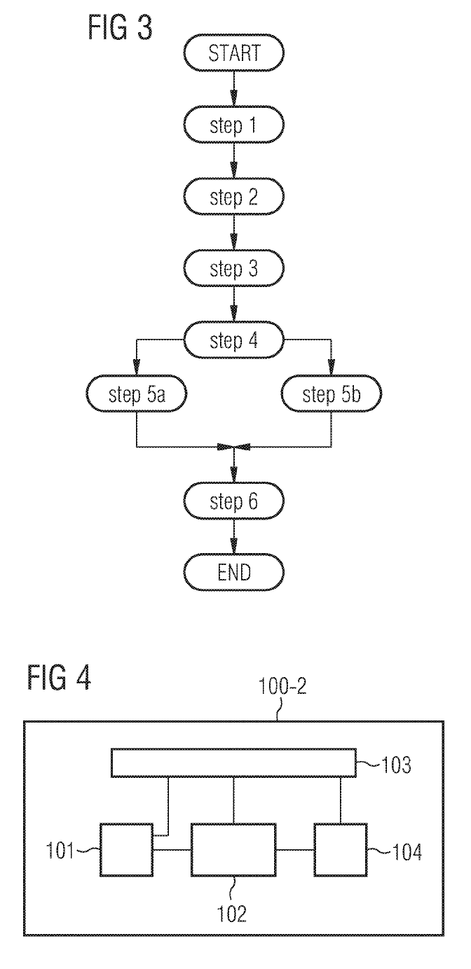

FIG. 3 depicts the operations performed by the technique described herein for preserving connectivity in the event of a failure.

In operation 1, controlling nodes 100-1, 100-2 maintain a database that stores information relating respectively to connectivity relationships between themselves and the group they control, as well as connectivity relationships of the controlling node they are to take over in the event of a failure. The information within the database can be inputted directly into each controlling node or can be requested by each controlling node from a supervising controlling node 200. Database updates can be transmitted between the controlling nodes 100-1, 100-2 whenever a connectivity relationship changes. In operation 2, a control link 50 is established between the first controlling node 100-1 and a further controlling node 100-2 using an lur or elur interface. Control link 50 can also be used for transmitting the database updates when they are necessary. In operation 3, the further controlling node 100-2 detects a failure F of the first controlling node 100-1, and in operation 4 controlling node 100-2 upon detecting the failure F of controlling node 100-1 connects using the information maintained in the database to the group A of nodes 10 via connection 5 and restores connectivity to group A.

Step Operation 4 further includes using at least one service parameter when connecting to nodes 10 of group A. The service parameter allows for a differentiation of the connection 5. This differentiation is specified by at least one of the following: an importance of each node 10 of the first group A, an importance of a user equipment 1 active within the first group A, an importance of a communication taking place within the first group A, an importance of a service provided by each node 10 of the first group A. The service parameters are stored in the databases of the controlling nodes 100-1, 100-2 including information relating to connectivity relationships between controlling nodes 100-1, 100-2 and their corresponding nodes 10 they control in their respective groups.

In this way the further controlling node 100-2 can differentiate between connecting to all nodes 10 of group A or to select a number of nodes 10 of group A and connect only to those selected. This differentiation is advantageous as it allows the further controlling node to perform load balancing when taking over group A, as it still has to maintain its own connection to its nodes 10 in group B.

The importance of each node 10 relates to the importance of the node within radio communications system 1000 or within the area covered by the different cells of group A. For example a node 10 lying in the centre of such an area and where a high amount of traffic is present will have a higher importance than a node 10 lying further away or in an area with a low amount of traffic.

The importance of a user equipment 1 active within the first group A, relates to the importance of the user equipment within the cell covered by its serving node and/or within the area covered by the different cells of group A. For example a user equipment 1 belonging to emergency services actively communicating will have a high importance and must not loose connectivity.

The importance of a communication taking place within the first group A, relates to the importance of a communication within the area covered by the nodes 10 of group A. For example a user equipment 1 actively communicating for example with an emergency call will have a high importance and must not loose connectivity, thus the node 10 that is serving the user equipment must have a connection 5 established.

The importance of a service provided by each node 10 of the first group A, relates to the importance of a service being provided by a node 10 to user equipments 1 present. For example a service such as a internet and/or television broadcast will have a higher importance and must not loose connectivity than a transmission of an email.

The at least one service parameter used can be at least a radio bearer service parameter. Also, a ARP (Allocation Retention Priority) parameter specifying the relative importance for allocation and retention of a radio bearer compared to other radio bearers can be used. Other parameters that can be used alone or in combination can be the following: traffic class, maximum bit rate, delivery order, maximum SDU (Service Data Unit) size, SDU format information, SDU error ratio, residual bit error ratio, delivery of erroneous SDUs, transfer delay; guaranteed bit rate, traffic handling priority.

The connection 5 set-up in operation 4 is set-up at least on a control plane between the at least one further controlling node 100-2 and the first group of nodes A. This enables the at least one further controlling node 100-2 to transmit and receive control messages to the nodes 10 that it is connected to. At a later moment in time after setting-up the control plane connection, it is also possible for the at least one further controlling node 100-2 to set-up a connection on a signalling plane. When setting-up the connection, the at least one further controlling node 100-2 uses IP (internet protocol) to set-up the connection with the first group of nodes A. When using IP, controlling node 100-2 uses the IP addresses of nodes 10 to transmit messages in order to set-up the connection with the first group of nodes A. The connection that controlling node 100-2 sets-up with nodes 10 is a one-to-one connection, as depicted in FIG. 1b, wherein controlling node 100-2 is connected directly to each node 10. Furthermore, when setting-up the connection, a further authentication and authorization between controlling node 100-2 and the first group of nodes A is executed during operation 4, in order to ensure that controlling node 100-2 gains control of the first group of nodes A in a smooth and efficient manner.

In a further refinement of the technique, operation 5a, once the connection in operation 4 is set-up, controlling node 100-2 retrieves dynamic data from the first group of nodes A and/or from at least one user equipment 1 of a plurality of user equipments present within the first group of nodes A. The retrieved dynamic data relates to at least one of the following types of data: configuration data, connectivity data, load situation data, of each one of the first group of nodes and the at least one user equipment 1. In the case of the user equipment 1 load situation data can be the available capacity of a buffer of the user equipment 1. Controlling node 100-2 retrieves the data and updates the information contained in its database concerning nodes 10 of the first group A and of user equipments 1 present within the area covered by the first group A.

As well as retrieving the dynamic data from the first group A and user equipment 1, controlling node 100-2 also updates a database 201, operation 5b, of at least one supervising controlling node 200-1 of a plurality of supervising controlling nodes 200-1, 200-2. The at least one supervising controlling node 200-1, being the controlling node for the first controlling node 100-1. In this way, the supervising controlling nodes 200-1, after having lost connection due to the failure F of controlling node 100-1, is made aware of the status of nodes 10 belonging to the group of node A as well as aware of the controlling node 100-2 that ensures the connectivity of the group A with the core network. The update from controlling node 100-2 to supervising controlling node 200-1 can be made over a control link 60. Control link 60, is either set-up when radio communications system 1000 is set in operation or is set-up once controlling node 100-2 takes over group A. IP or another protocol can be used to transmit and receive messages between the node 100-2 and 200-1.

In a further refinement of the technique, 6, once the failure F is resolved, either by a software action performed over the radio communications system 1000 or by hardware replacement and re-initialisation of controlling node 100-1, the first controlling node 100-1 re-connects to the first group of nodes A, and the at least one further controlling node 100-2 releases the connection it had established. Upon re-connection, supervising controlling node 200-1 is made aware of the failure resolution and the re-connection of controlling node 100-1 to group A.

FIG. 4 depicts in block diagram format an arrangement for executing the technique that are included within a controlling node 100-2.

Controlling node 100-2, for example a radio network controller (RNC) or a control plane server (CPS). An RNC acts as an interface between nodes 10 and the core network, while a CPS acts as an interface for executing the transmission control of a control signal for transmitting data from nodes 10.

Controlling node 100-2 includes a database 101 storing information relating to connectivity relationships between a first controlling node 100-1 and a first group of nodes A. Control unit 102 arranged to establish, via transceiver 103, a control link 50 to the first controlling node 100-1. Control unit 102 is further arranged to control the functioning of the controlling node 100-2, while transceiver 103 is arranged to transmit and receive messages over control and/or signalling connections. Control unit 102 coupled to detecting unit 104 arranged to detect the failure F of the first controlling node 100-1 over control link 50. Detecting unit 104 is further arranged to detect a failure F of a logical and/or a physical connection to the first controlling nodes A. In one refinement of the technique, detecting unit 104 is further arranged to use at least a radio network sublayer application part protocol to detect the failure F of the logical connection.

Transceiver 103 is further arranged upon detection of the failure F, to connect to the first group of nodes A using the information stored in the database 101. Transceiver 103 sets the connection to the first group A at least over a control plane using an internet protocol and are further arranged to connect to each node of the first group of nodes using a one to one connection. Transceiver 103 also sets the connection to the first group A over a signalling plane if required.

Control unit 102 further uses at least one service parameter when connecting to the first group (A), the at least one service parameter differentiating the connection by specifying at least one of the following: an importance of each node (10) of the first group (A), an importance of a user equipment (1) active within the first group (A), an importance of a communication taking place within the first group (A), an importance of a service provided by each node (10) of the first group (A).

Furthermore, control 102 is further adapted upon connecting to the first group A of nodes via transceiver 103, to retrieve via the transceiver 103 dynamic data from the first group of nodes A. The dynamic data relating to at least one of the following: configuration, connectivity, load situation data of each one of the first group of nodes A.

In a further refinement, control 102 is further adapted upon connecting to the first group of nodes A via transceiver 103, to update via the transceiver 103 a database 201 of at least one supervising controlling node 200-1 of a plurality of supervising controlling nodes 200-1, 200-2. The at least one supervising controlling node 200-1 adapted to control the first controlling node 100-1.

Additionally, once the failure F is resolved, either by a software action performed over the radio communications system 1000 or by hardware replacement and re-initialisation of controlling node 100-1, control unit 102 further releases the connection established with the first group A. The handover of the control of group A is handled using standard handover procedures.

Additionally, the technique still works even if the connection 50 to the first controlling node fails rather than the first controlling node failing itself. The controlling node still remains the central point for handling RRM requests received from UEs from the core network side. The technique separates radio management functions which require detailed knowledge and information of the physical radio resources from service request functions which do not require such detailed knowledge and information, thus simplifying the management of the controlling node.

Furthermore, the technique is flexible in that it enables sharing the additional work required when taking over the responsibilities, e.g. RRM, of a failed controlling node by an arbitrary number of replacement controlling nodes independently of the geographical location of the failed and the replacement node(s). Additionally, during normal operation, i.e. when no failure is detected, retrieval or exchange of dynamic data for maintaining the databases is not required, thus reducing the amount of traffic generated by controlling nodes communicating with each other.

The system also includes permanent or removable storage, such as magnetic and optical discs, RAM, ROM, etc. on which the process and data structures of the present can be stored and distributed. The processes can also be distributed via, for example, downloading over a network such as the Internet. The system can output the results to a display device, printer, readily accessible memory or another computer on a network.

Although the invention has been described in terms of an embodiment herein, those skilled in the art will appreciate other embodiments and modifications which can be made without departing from the scope of the teachings of the invention. All such modifications are intended to be included within the scope of the claims appended hereto which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-17. (canceled)

18. A method for restoring connectivity in a radio communications system upon failure of a first controlling node among controlling nodes, the first controlling node controlling a first group of the controlling nodes, comprising:
maintaining a database in at least a second controlling node controlling a second group of the controlling nodes, the database storing information relating to connectivity relationships between the first controlling node and the first group;
establishing at least one control link between the first controlling node and at least the second controlling node;
detecting, by at least the second controlling node, failure of the first controlling node via the at least one control link; and
connecting, upon detection of the failure, by at least the second controlling node to the first group using the information stored in the database.

19. A method according to claim 18, wherein said connecting sets up a connection at least on a control plane between at least the second controlling node and the first group.

20. A method according to claim 19, wherein the connection on the control plane is set-up using an internet protocol.

21. A method according to claim 20, wherein the connection between at least the second controlling node and a node of the first group is a one-to-one connection.

22. A method according to claim 21, wherein said connecting further comprises at least authenticating and authorizing between at least the second controlling node and the controlling nodes of the first group.

23. A method according to claim 22, wherein said detecting the failure over the control link detects a failure of a logical and/or of a physical connection between the first controlling node and at least the second controlling node.

24. A method according to claim 23, wherein the logical connection includes at least a radio network sublayer application part protocol.

25. A method according to claim 24, further comprising upon said connecting, retrieving, by at least the second controlling node, node dynamic data from the controlling nodes of the first group, the node dynamic data relating to at least one of configuration data, connectivity data and load situation data of each controlling node of the first group.

26. A method according to claim 25, further comprising upon said connecting, retrieving, by at least the second controlling node, user dynamic data from at least one user equipment active within the first group, the user dynamic data relating to at least one of configuration data and connectivity data of the at least one user equipment.

27. A method according to claim 26, further comprising upon said connecting, updating, by at least the second controlling node, a supervisory database of at least one supervisory controlling node of a plurality of supervising controlling nodes, the at least one supervisory controlling node controlling the first controlling node as well as at least the second controlling node.

28. A method according to claim 25, wherein at least the second controlling node uses at least one service parameter when connecting to the first group to differentiate the connection, thereby enabling at least the second controlling node to connect to all nodes or a portion of the controlling nodes of the first group.

29. A method according to claim 28, wherein the at least one service parameter specifies at least one of an importance of each controlling node in the first group, an importance of user equipment active within the first group, an importance of communication taking place within the first group, and an importance of a service provided by each controlling node in the first group.

30. A method according to claim 29, wherein the at least one service parameter is at least one of a radio bearer service parameter and an allocation retention priority parameter.

31. A method according to claim 30, further comprising, upon the failure being resolved,
reconnecting the first controlling node to the first group, and
releasing the connection to the first group by at least the second controlling node.

32. A controlling node, controlling a first group of controlling nodes in a radio communications system, for restoring connectivity upon a failure of another controlling node controlling a second group of the controlling nodes, comprising:
a database storing information relating to connectivity relationships between the other controlling node and the second group;
a control unit establishing a control link to the other controlling node;
a detection unit detecting failure of the other controlling node via the control link; and
a transceiver connecting to the second group using the information stored in said database upon detection of the failure.

33. A controlling node according to claim 32, wherein the controlling node is one of a radio network controller and a control plane server.

34. A radio communications system comprising controlling nodes, said controlling nodes including
a first controlling node controlling a first group of said controlling nodes; and
a second controlling node, controlling a second group of said controlling nodes, including
a database storing information relating to connectivity relationships between the first controlling node and the first group;
a control unit establishing a control link to the first controlling node;
a detection unit detecting failure of the first controlling node via the control link; and
a transceiver connecting to the first group using the information stored in said database upon detection of the failure.

35. A radio communications system according to claim 34, wherein said second controlling node is one of a radio network controller and a control plane server.
